(19) United States
(12) Patent Application Publication
(10) Pub. No.: US 2007/0175083 A1
(43) Pub. Date: Aug. 2, 2007

(54) Segmented soft plastic lure in the form of a fish

(76) Inventors: Scott Wilson, Deland, FL (US); Renata Marie Wilson, Deland, FL (US); Timothy Jay Wilson, Baltimore, MD (US); Jason Scott, Rio Rico, AZ (US)

Correspondence Address: GORDON & JACOBSON, P.C., 60 LONG RIDGE ROAD, SUITE 407, STAMFORD, CT, 06902, US

(21) Appl. No.: 11/342,934

(22) Filed: Jan. 30, 2006

(51) Int. Cl. A01K 85/00; A01K 85/18

(52) U.S. Cl. 43/42.15; 43/42.24; 43/42.39; 43/42.37

(57) ABSTRACT

A soft plastic articulating fishing lure includes a head and a plurality of body sections integrally molded with hinge sections. The hinge sections are preferably smaller in height than the respective body sections they join to promote increased swimming action at lower pull speed. Central body sections are preferably molded with relatively rounded back and relatively flatter front to promote water flow to effect swim-like movement of the lure. When fished, the lure articulates at the hinge joints only. In one embodiment, the head portion includes a molded slot, and a weighted insert is provided therein defining eyes for fishing line and hook, and a weights for lure control. In another embodiment, an insert with hook is provided within a slot in the head of the head and the hook is caused to rotate upwards out of the recess and into the mouth of the fish to hook the fish.

### BACKGROUND OF THE INVENTION

1. Field of the Invention

This invention relates broadly to fishing lures. More particularly, this invention relates to flexible segmented lures in the form of a fish.

2. State of the Art

Fishermen have for centuries attempted to design or discover the perfect bait to lure their intended catch to their hook. Fishermen know that fish are instinctively attracted to the movement of live bait. Unfortunately, it is not always possible or convenient for a fisherman to carry or fish with live bait. Further, live bait is more expensive to use, is not always readily available, and is difficult to place on a barbed hook without killing the bait or otherwise greatly reducing its ability or desire to move naturally.

Over the years, fishing equipment manufacturers have made numerous attempts to perfect an artificial fishing lure which simulates characteristics of a variety of types of live bait fish. The lures have been generally carved from wood or molded from rigid plastic to closely simulate the look of the particular bait fish. While manufacturers of such lures have partially succeeded in designing artificial bait with a generally life-like in appearance, there have been a great many more failures than successes in designing a lure which simulates the movements of live bait in actual use. One proposed mechanism to simulate a live bait with a hard motion lure is to provide the lure with several discrete body elements which can articulate relative to each other. U.S. Pat. No. 1,402,798 to Ryan, U.S. Pat. No. 1,557,644 to Andersen, U.S. Pat. No. 2,535,392 to Dale, and U.S. Pat. No. 5,522,170 to Cole each disclose lures having articulating body elements. Nevertheless, even such lures fail to move in a realistic manner when pulled through the water and project a somewhat clumsy movement.

Co-owned U.S. Pat. No. 6,460,286 describes a rigid lure with discrete sections that has been one of the few successful lures of its type. Reasons for its success include its realistic swimming motion when pulled through the water. This is due to a combination of an internal air chamber for upright stability, a particular snap fit hinge assembly between sections, and a rounded shape to the rear portion and flat front adjoining portion to the respective sections of the lure which results in water flow across the lure which results in side-to-side back and forth swimming action. However, hard plastic lures are relatively expensive to manufacture and, if lost, for the angler to replace.

An altogether different type of lure, with its own considerations, is the soft plastic lure, generally molded from a polyvinylchloride or other soft plastic. Soft plastic lures can be molded to be much more realistic in appearance and are less expensive to manufacture. In further distinction from hard plastic lures, soft plastic lures are generally not hinged because they are already flexible. In addition, while they are flexible and move within the water, the movement they have is not particularly fish-like in the water, but rather more similar to worms or flat baits. Further, when such fish-like lures are pulled, they do not generally swim with the fin vertically oriented; i.e., as a fish would normally swim. This is because soft plastic lures are more difficult to provide with upright stability than a rigid lure.

### SUMMARY OF THE INVENTION

It is therefore an object of the invention to provide a soft plastic fishing lure which simulates the appearance of a bait fish.

It is another object of the invention to provide a soft plastic fishing lure which simulates the movement of a bait fish when pulled through water.

It is a further object of the invention to provide a soft plastic fishing lure which has upright stability in the water.

It is also an object of the invention to provide a fish luring which is particularly adapted for hooking fish.

In accord with these objects, which will be discussed in detail below, a soft plastic articulating fishing lure is provided which includes a head and a plurality of soft plastic body sections integrally molded with hinge sections. The hinge sections are preferably smaller in height than the respective body sections they join to promote increased swimming action at lower pull speed. Central body sections are preferably molded with relatively rounded back and relatively flatter front to cause the water flow to create swim-like movement of the lure as the lure is pulled through the water.

In one embodiment, the head portion of the lure includes a preferably molded slot which extends diagonally forward from a central portion of the head to preferably slightly forward of an eye location. An insert is provided into the slot and includes an upper eye for attachment of fishing line and a lower eye for attachment of a hook. The insert also includes a weight element which functions as ballast for the lure to maintain the lure in an upright orientation. As the lure is pulled through the water, the lure is pushed by the water against the weight element and the weight element includes a surface which supports the soft plastic of the lure so that the lure swims straight and realistically. In addition, the weight element can be colored to function as an attractant. Furthermore, the insert can easily be removed from the slot in the lure and replaced with insert having different weights and/or colors for different fishing conditions and for functioning as various attractants for fish of different types.

In another embodiment, the head portion of the lure includes a central recess having an upper opening between the sides of the head, a molded wall at the front of the recess, and a hole into the wall. An insert is provided including a hook, a retainer, and a nose weight with a line eye attached at the top thereof. The hook and retainer portion are inserted through the hole, with the hook residing in the recess and the barb engaging the wall to couple the insert within the lure. The nose weight forms the front end of the lure. When fishing line is attached to the line eye and pulled against the fishing lure (e.g., when the lure is struck by a fish), the hook is caused to rotate upwards out of the recess and into the mouth of the fish to hook the fish.

Additional objects and advantages of the invention will become apparent to those skilled in the art upon reference to the detailed description taken in conjunction with the provided figures.

### BRIEF DESCRIPTION OF THE DRAWINGS

FIG. 1 is a side elevation of a soft lure according to a first embodiment of the invention;

FIG. 2 is a is a top view of the lure of FIG. 1;

FIG. 3 is a top view of an alternative embodiment of the lure of FIG. 1;

FIG. 4 is a side elevation of a soft lure according to a second embodiment of the invention;

FIG. 5 is a top view of the lure of FIG. 4; and

FIG. 6 is a side elevation of the configuration of the lure of FIG. 4 when the lure and fishing line coupled to the lure are subject to opposite pulling forces.

### DETAILED DESCRIPTION

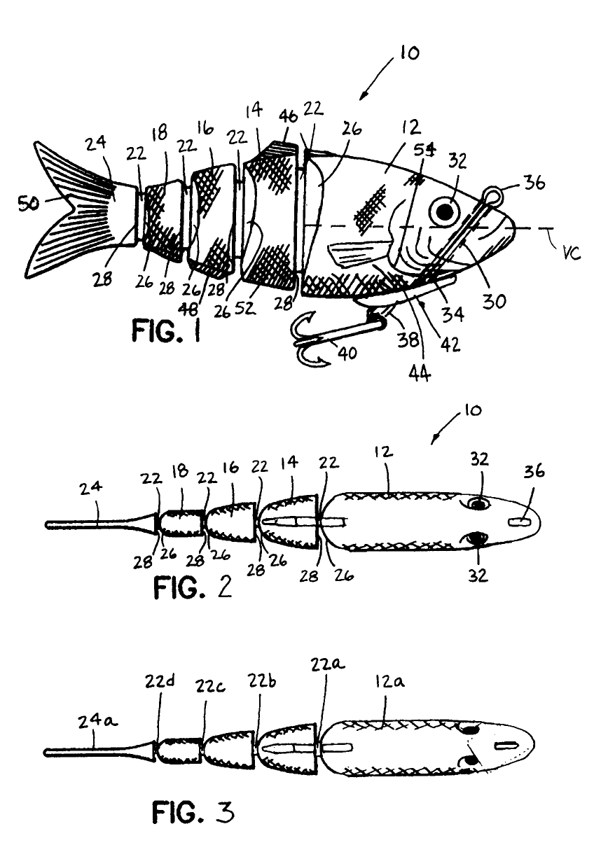

Turning now to FIGS. 1 and 2, a soft plastic flexible articulating fishing lure 10 according to a first embodiment of the invention is shown. The lure 10 includes a head portion 12 and a plurality of soft plastic body portions 14, 16, 18 integrally molded to the head portion 12 with hinge sections 22. The lure preferably also includes a tail portion 24 integrally molded to the last body portion with another hinge section 22. The hinge sections 22 are substantially thinner in a side-to-side dimension than the head, body and tail portions and also preferably smaller in height than the respective portions they join to promote increased swimming action (articulation), particularly at lower pull speeds.

By way of example, in a preferred embodiment, the head portion 12 has a maximum side-to-side thickness of approximately 0.6 inch and the smallest body portion 18 has a maximum side-to-side thickness of approximately 0.35 inch, while the hinge sections 22 have a substantially uniform side-to-side thickness of approximately 0.05 inch. Thus, in the preferred embodiment, the hinge sections 22 are less than 25 percent the thickness of the head and body portions, and substantially 8 to 15 percent the thickness of the head and body portions. In addition, in the preferred example, the hinge sections 22 have a height of approximately 60-85 percent, and most preferably approximately 63-73 percent, the adjoining head, body, or tail portions.

Referring to FIG. 3, according to an alternative embodiment, the hinge sections 22a, 22b, 22c, 22d have varying thicknesses, preferably decreasing from the head portion 12a back toward the tail portion 24a to further promote swimming action. In the embodiment shown in FIG. 3, the hinge sections preferably, but not necessarily, have a height smaller than adjoining head, body and tail portions.

Referring back to FIGS. 1 and 2, the back 26 of each of the head section 12 and body sections 14, 16, 18 is preferably rounded, and the body sections are preferably molded with a relatively flatter front 28. When the lure 10 is pulled through water, the water moves across the rounded backs 26 and contacts the flatter fronts 28 causing the lure to articulate at the hinges 22 and to a take on swim-like movement.

In each the main and alternative embodiments, as the lure is pulled through the water, the lure articulates side-to-side. While the lure is made from a flexible material, when pulled through the water the hinges and construction cause the lure to move on itself at the hinge joints only, with the head and body portions functioning as if they are substantially rigid.

The head portion 12 of the lure 10 includes a preferably molded slot 30 which extends diagonally forwards and upwards from a lower central portion of the head to preferably slightly in front of an eye location 32. An insert 34 is provided with a portion in the slot 30 and includes an upper eye 36 for attachment of fishing line and a lower eye 38 for attachment of a hook 40. The first and second eyes 36, 38 are longitudinally and vertically offset such that the first eye 36 is located forward on the lure and vertically above the second eye 38. The insert 34 also includes a weight 42 which functions as ballast for the lure to maintains the lure in an upright orientation. Further, as the lure is pulled through the water, the lure is pushed against the weight 42 and the weight includes an upper surface 44 which supports the soft plastic of the lure so that the lure swims stably and realistically. In addition, the insert 34 and particularly the large weight portion 42 can be colored to function as an attractant. Furthermore, the insert 34 can easily be removed from the slot 30 in the lure and replaced with inserts of different weights and/or colors for different fishing conditions and for functioning as various attractants for fish of different types.

The lure 10 has the appearance of a bait fish, with a narrow width and relatively larger, shallow sides. The lure preferably includes a top fin 46, bottom fin 48, and a tail fin 50, and may include indicia for scales 52, gill openings 54, etc.

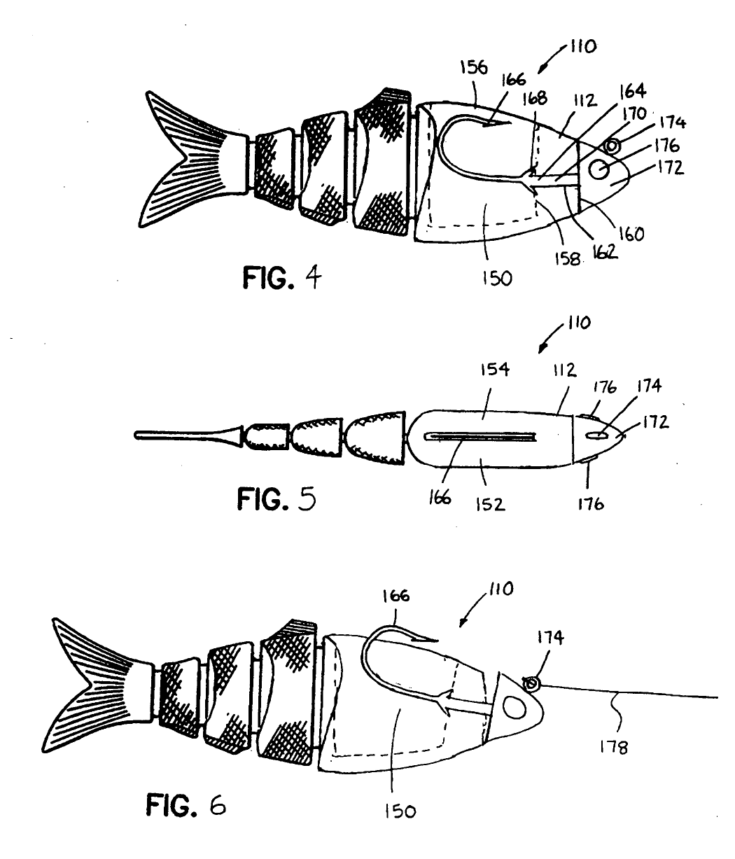

Turning now to FIGS. 4 and 5, a second embodiment of a lure 110 according to the invention is shown. The second embodiment is substantially similar to the first embodiment in the manner in which the head, body and tail portions of the lure are preferably integrally molded together from a flexible plastic material. The head portion 112 of the lure 110 includes a central recess 150 having an upper opening 156 between the sides 152, 154 of the head portion 112, a wall 158 at the front of the recess, a preferably flat front 160, and a hole 162 extending from the front and into the recess. An insert 164 is provided including a hook 166, an insert retention barb 168, a retainer portion 170, and a nose weight 172 with a fishing line eye 174 attached at the top thereof. The hook 166, barb 168 and retainer portion 170 are inserted through the hole 162, with the hook 166 residing in the recess 150 and the barb 168 engaging the wall 158 to engage the insert 164 within the lure. The nose weight 172 forms the nose of the lure and preferably includes indicia of fish eyes 176.

Referring to FIG. 6, when fishing line 178 is attached to the fishing line eye 174 and then pulled against the fishing lure 110 (i.e., if the lure is struck by a fish), by locating the fishing line eye 174 above the center of the insert 164, a moment arm is created which results in temporary material deformation at the front of the lure and the hook 166 rotating upwards out of the recess 150 and into the mouth of the fish to engage or ‘hook’ the fish.

Preferred materials for manufacturing the lure include polyvinylchloride (PVC) and other soft injectable plastics. The head and body portions as well as hinge sections are preferably comprised of a single plastic material injection molded at a single time. The preferred durometer of the plastic is preferably under 50, more preferably under 40, and most preferably under 30.

There have been described and illustrated herein embodiments of a soft plastic articulating fishing lure. While particular embodiments of the invention have been described, it is not intended that the invention be limited thereto, as it is intended that the invention be as broad in scope as the art will allow and that the specification be read likewise. By way of example, the inserts of either embodiment may be used in a flexible lure that has features different from the lures described and particularly in lures that are non-articulating. It will therefore be appreciated by those skilled in the art that yet other modifications could be made to the provided invention without deviating from its spirit and scope as claimed.

1. A fishing lure, comprising:
a) a soft plastic head portion;
b) a plurality of soft plastic body portions;
c) a plurality of soft plastic flexible hinge sections integrally molded with the head and body portions,
wherein the lure has the appearance of a bait fish and when the lure is fished the body portions articulate relative to each other and the head portion in a side-to-side motion at the hinge sections.

2. A lure according to claim 1, further comprising:
a tail portion integrally molded to a body portion with a hinge section.

3. A lure according to claim 1, wherein:
at least one hinge section is less than 25 percent the thickness of the head portion.

4. A lure according to claim 1, wherein:
at least one hinge section is less than approximately 15 percent the thickness of the head portion.

5. A lure according to claim 1, wherein:
at least one hinge section is approximately 8 percent the thickness of the head portion.

6. A lure according to claim 1, wherein:
at least a plurality of the hinge sections have a height of approximately 60 to 85 percent the height of adjoining portions of the lure.

7. A lure according to claim 1, wherein:
all the hinge sections have heights of approximately 60 to 85 percent the height of the adjoining portions of the lure.

8. A lure according to claim 1, wherein:
all the hinge sections have heights of approximately 63 to 73 percent the height of the adjoining portions of the lure.

9. A lure according to claim 1, wherein:
the hinge sections vary in thickness.

10. A lure according to claim 9, wherein:
respective hinge sections vary in thickness, with thinner hinge sections being located further from the head portion.

11. A lure according to claim 1, wherein:
the head portion includes a back, and each of the body portions includes a back and a front, wherein the backs are relatively rounded and the fronts are relatively flatter.

12. A lure according to claim 1, further comprising:
an insert including a first eye, a second eye, and a weighted element, one of said first and second eyes for attachment of fish hook and the other for attachment of fishing line,
wherein the head portion of the lure includes a slot, and a portion of the insert including the first eye is inserted through the slot and out of the head portion such that the head portion is located between the first eye and the weighted element, and
when the lure is in water, the weighted element maintains the lure in an upright orientation.

13. A lure according to claim 12, wherein:
the first and second eyes are longitudinally and vertically offset such that the first eye is located forward on the lure and above the second eye.

14. A lure according to claim 1, further comprising:
an insert including a hook, insert retention structure, a weighted element, and a fishing line eye attached at an upper portion of the weighted element,
wherein the lure includes a central recess having an upper opening between the sides of the head portion,
the hook residing in the recess and coupled therein by the insert retention structure, and the weighted element positioned at the front of the lure,
wherein when fishing line is attached to the fishing line eye and pulled against the fishing lure, the hook is rotated upwards out of the recess.

15. A fishing lure, comprising:
a) head and body portions comprised of a soft flexible plastic; and
b) an insert including a first eye, a second eye, and a weighted element, one of the first and second eyes for attachment of a fish hook and the other for attachment of fishing line,
wherein the head portion of the lure includes a longitudinal slot open at the top of the lure through which the hook can be moved, and a portion of the insert including the first eye is inserted through the slot and out of the head portion such that the head portion is located between the first eye and the weighted element,
wherein when force is applied to the fish eye that receives fishing line relative to the body portions, a portion of the hook rotates upwards out of the slot in the head portion, and
said weighted element is located below a vertical center of said head portion, is coupled in contact with a lower exterior surface of said head portion, and has sufficient mass to function as a ballast for the lure to orient the lure upright in water.

16. A lure according to claim 15, wherein:
the first and second eyes are longitudinally and vertically offset such that the first eye is located forward on the lure and above the second eye.

17. A lure according to claim 15, wherein:
the head and body portions are integrally molded with flexible hinge sections which are thinner than adjoining head and body portions.

18. A lure according to claim 17, wherein:
at least one of the hinge sections has a height which is smaller than the head and/or body portions which it adjoins.

19. A lure according to claim 15, wherein:
a plurality of the hinge sections have heights which are smaller than the head and/or body portions which they adjoin.

20. A lure according to claim 19, wherein:
all the hinge sections have heights of approximately 60 to 85 percent the height of the adjoining portions of the lure.

21. A fishing lure, comprising:
a) head and body portions comprised of a soft flexible plastic; and
b) an insert including a hook, insert retention structure, a weighted element, and a fishing line eye attached at an upper portion of the weighted element,
wherein the lure includes a central recess having an upper opening between the sides of the head portion,
the hook residing in the recess and coupled therein by the insert retention structure, and the weighted element positioned at the front of the lure,
wherein when fishing line is attached to the fishing line eye and pulled against the fishing lure, the hook is rotated upwards out of the recess.

22. A lure according to claim 21, wherein:
the head and body portions are integrally molded with flexible hinge sections which are thinner than adjoining head and body portions.

23. (canceled)

24. A lure according to claim 23, wherein:
at least one of the hinge sections has a height which is smaller than the head and/or body portions which it adjoins.

25. A lure according to claim 21, wherein:
a plurality of the hinge sections have heights which are smaller than the head and/or body portions which they adjoin.

26. A lure according to claim 25, wherein:
all the hinge sections have heights of approximately 60 to 85 percent the height of the adjoining portions of the lure.
